(19) United States
(12) Patent Application Publication
(10) Pub. No.: US 2009/0318605 A1
(43) Pub. Date: Dec. 24, 2009

(54) POLYMER ADDITIVES CONTAINING PARTICLES

(75) Inventors: Rainer Dyllick-Brenzinger, Neustadt (DE); Alban Glaser, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/439,928

(22) PCT Filed: Sep. 18, 2007
(86) PCT No.: PCT/EP2007/059812

§ 371 Date: Mar. 4, 2009

(30) Foreign Application Priority Data
Sep. 20, 2006 (EP) 06120954.0

(51) Int. Cl. C08J 3/02

(52) U.S. Cl. 524/457; 428/402

(57) ABSTRACT

Particles which can be obtained by aqueous emulsion polymerization of ethylenically unsaturated monomers M in the presence of polymer additives and of seed latexes, in which the monomers M comprise largely water-insoluble monomers M1 and optionally at least partially water-soluble monomers M2, and the polymer additives are essentially water-insoluble and are soluble in the monomers M1 and cannot be polymerized under conditions for the preparation of the particles, and the particles exhibit a mean particle size of at most 500 nm.

The present invention relates to particles, based on ethylenically unsaturated monomers, which comprise polymer additives and to the use of these particles in the treating of organic polymers, in particular for stabilizing against the effect of UV radiation. The invention furthermore relates to aqueous polymer dispersions which comprise such particles and to processes for the preparation of these polymer dispersions. The present invention comprises polymer powders which can be obtained from the abovementioned polymer dispersions and also polymer dispersions which can be obtained by redispersing the polymer powders.

Additional embodiments of the present invention can be taken from the claims, the description and the examples. It is understood that the preceding characteristics and the succeeding characteristics still to be explained of the subject matter of the invention can be used not only in the combination given each time in concrete terms but also in other combinations without departing from the scope of the invention. The embodiments of the present invention in which all characteristics have the preferred or particularly preferred meanings are preferred or particularly preferred.

The preparation of insecticide-comprising polymers by emulsion polymerization of monomers comprising vinyl groups is known from U.S. Pat. No. 3,400,093. The insecticides are in this connection insoluble in the emulsion medium but soluble in the monomers. The use of seed latexes is not disclosed in U.S. Pat. No. 3,400,093.

U.S. Pat. No. 4,419,471 discloses polymer compositions with a styrene/butadiene core and an alkyl acrylate/methacrylate shell. The styrene/butadiene core is used as seed latex. The core comprises antioxidants and is at least partially surrounded by a unified shell. The shell comprises a copolymerized UV stabilizer.

WO 01/10936 discloses polymer particles with a core/shell structure, the core of which comprises a UV absorber. The UV absorber can either be incorporated chemically in the polymer core or can be attached to the polymer core or can be dispersed in the core. The preparation of the polymer particles which is shown in the examples is carried out without seed latex.

WO 05/102044 discloses aqueous fungicidal active substance compositions and the use thereof in combating harmful microorganisms. The compositions comprise a finely divided polymer with a mean particle size of less than 300 nm. The finely divided polymers are prepared by emulsion polymerization of ethylenically unsaturated monomers, inter alia also obtained in the presence of a seed latex. The active substance present in the particles is released from the particles when used to combat microorganisms.

In the processes mentioned of the state of the art, the ingredients used escape from the polymers into the surroundings. This is, except in the cases of the insecticidal or fungicidal active substances, undesirable. A decrease in the ingredients by migration out of the polymers results in a diluting and frequently in reduced effectiveness. If it is desired to ensure that the ingredients remain in the particles on a long term basis, the teaching of the state of the art accordingly provides the alternatives of incorporating the ingredients chemically as comonomers in the polymers or of attempting to encapsulate them in the core of core/shell particles. However, both actions limit either the choice of the possible ingredients or result, from time to time, in an inadequate long term effect.

It is therefore an object of the present invention to make available particles which comprise polymer additives in a way which guarantees stability toward migration, i.e. the polymer additives remain in the particle as much as possible over a long period of time. An additional object of the invention is to find the improved preparation processes which make possible efficient access to particles stable toward migration. In addition, the particles should be easy to incorporate in organic polymers.

These and other objects are achieved, as is clear from the disclosure content of the present invention, by the various embodiments of the process according to the invention which are described subsequently.

It has surprisingly been found that this object is achieved by particles which can be obtained by aqueous emulsion polymerization of ethylenically unsaturated monomers M in the presence of polymer additives and of seed latexes, in which the monomers M comprise
a. largely water-insoluble monomers M1, and
b. optionally at least partially water-soluble monomers M2, and the polymer additives
c. are essentially water-insoluble and
d. are soluble in the monomers M1 and
e. cannot be polymerized under conditions for the preparation of the particle and the particles exhibit a mean particle size of at most 500 nm.

Expressions of the form Cₐ-C_{b} describe, in the context of this invention, chemical compounds or substituents with a particular number of carbon atoms. The number of carbon atoms can be chosen from the entire range from a to b, including a and b, a is at least 1 and b always greater than a. An additional specification of the chemical compounds or of their substituents results from expressions of the form Cₐ-C_{b}-V. In this connection, V is a category of chemical compound or a category of substituent, for example is alkyl compounds or alkyl substituents.

According to the invention, the particles are prepared based on ethylenically unsaturated monomers M. The monomers M can be identical or different. If all monomers M are identical, the polymer prepared from them thus consists of homopolymers while, with different monomers M, the polymer consists of copolymers. The particles according to the invention comprise one or more polymers of the monomers M. The particles can accordingly also comprise blends of identical or different homo- or copolymers. In principle, all ethylenically unsaturated monomers which can be polymerized according to the method of aqueous emulsion polymerization are suitable as monomers M.

A subset of M represents the neutral, ethylenically unsaturated and largely water-insoluble monomers M1. Preferably, the monomers M1 are monoethylenically unsaturated. The monomers M1 can be all identical or different. Monomers M1 suitable as monomers M comprise vinylaromatic monomers, such as styrene, vinyl ethers, esters of monoethylenically unsaturated mono- and dicarboxylic acids with 3 to 12 and in particular 3 or 4 carbon atoms with C₁-C₁₂-alkanols or with C₅-C₈-cycloalkanols, in particular the esters of acrylic acid, of methacrylic acid or of crotonic acid, the diesters of maleic acid, of fumaric acid or of itaconic acid and particularly preferably the esters of acrylic acid with C₂-C₁₂-alkanols, described as C₂-C₁₂-alkyl acrylates, such as ethyl acrylate, n-butyl acrylate, isobutyl acrylate, tert-butyl acrylate, n-hexyl acrylate, 2-ethylhexyl acrylate, 3-propylheptyl acrylate or lauryl acrylate and the esters of methacrylic acid with C₁-C₁₂-alkanols, referred to as C₁-C₁₂ alkyl methacrylates, such as methyl methacrylate, ethyl methacrylate, n-butyl methacrylate, isobutyl methacrylate, tert-butyl methacrylate, or n-hexyl methacrylate, and also methacrylonitrile or acrylonitrile. Suitable monomers M1 are also vinyl or allyl esters of aliphatic carboxylic acids with 2 to 10 carbon atoms, for example vinyl acetate, vinyl propionate and the vinyl esters of Versatic® acids (vinyl versatates), vinyl halides, such as vinyl chloride or vinylidene chloride, conjugated diolefins, such as butadiene or isoprene, and C₂-C₆-olefins, such as ethylene, propene, 1-butene or n-hexene. Preferred monomers M1 are vinylaromatic monomers, in particular styrene, C₂-C₁₂-alkyl acrylates, in particular C₂-C₈-alkyl acrylates or C₁-C₁₂-alkyl methacrylates, vinyl acetate, vinyl ethers and also methacrylonitrile or acrylonitrile.

The particles are preferably formed to from 60 to 100% by weight, based on the total amount of the monomers M, preferably to 70 to 100% by weight and particularly preferably to 80 to 100% by weight of monomers M1.

The solubilities, for example aqueous solubilities, given are measured under standard conditions, at a temperature of 25° C. and a pressure of 1013 mbar. The solubilities of the monomers are, for example, determined by dropping monomer into deionized water until a visually visible phase boundary develops.

The monomers M1 are largely water-insoluble. Preferably, the monomers M1 accordingly exhibit an aqueous solubility of not more than 30 g/l. In particular, the aqueous solubility of the monomers M1 is, under these conditions, from 0.05 to 20 g/l.

In addition, the monomers M optionally comprise ethylenically unsaturated and at least partially water-soluble monomers M2. The monomers M optionally comprise from 0.01 to 40% by weight, based on the total amount of the monomers M, preferably optionally from 0.01 to 30% by weight, in particular optionally from 0.01 to 20% by weight, of monomers M2 other than the monomers M1. The sum of the proportions of monomers M1 and M2 naturally results in 100% by weight, based on the total amount of the monomers M, if only monomers M1 and M2 are used for the monomers M. The monomers M2 exhibit an aqueous solubility of at least 50 g/l and in particular of at least 100 g/l.

The solubility of the monomers M2 in M1 can vary. Generally, less monomer M2 will be dissolved in M1 at low polarity of the monomer M1; however, this can be quickly discovered by simple solubility experiments.

The monomers M2 include in particular monoethylenically unsaturated monomers M2a which exhibit an aqueous solubility of at least 50 g/l and in particular of at least 100 g/l and which exhibit at least one acid group or at least one anionic group, in particular monomers M2a which exhibit a sulphonic acid group, a phosphonic acid group or one or two carboxylic acid groups, and also the salts of the monomers M2a, in particular the alkali metal salts, e.g. the sodium or potassium salts, and the ammonium salts. These include ethylenically unsaturated sulfonic acids, in particular vinylsulfonic acid, 2-acrylamido-2-methylpropanesulfonic acid, 2-acryloyloxyethanesulfonic acid or 2-methacryloyloxyethanesulfonic acid, 3-acryloyloxy- or 3-methacryloyloxypropane-sulfonic acid or vinylbenzenesulfonic acid, or the salts thereof, ethylenically unsaturated phosphonic acids, such as vinylphosphonic acid or vinylphosphonic acid dimethyl ester, or the salts thereof, or α,β-ethylenically unsaturated C₃-C₈-mono- or C₄-C₈-dicarboxylic acids, in particular acrylic acid, methacrylic acid, crotonic acid, maleic acid, fumaric acid or itaconic acid. The optional proportion of the monomers M2a will frequently come to not more than 35% by weight, based on the total amount of the monomers M, preferably not more than 20% by weight, e.g., from 0.01 to 20% by weight and in particular from 0.01 to 15% by weight.

Preferred monomers are acrylic acid and methacrylic acid, and also itaconic acid, and the alkali salts thereof.

The monomers M2 furthermore include the monoethylenically unsaturated, neutral and at least partially water-soluble monomers M2b which exhibit an aqueous solubility of at least 50 g/l and in particular of at least 100 g/l. Examples of this are the amides of the abovementioned ethylenically unsaturated carboxylic acids, in particular acrylamide or methacrylamide, hydroxyalkyl esters of the abovementioned α,β-ethylenically unsaturated C₃-C₈-monocarboxylic acids or C₄-C₈-dicarboxylic acids, in particular hydroxyethyl acrylate, hydroxyethyl methacrylate, 2- or 3-hydroxypropyl acrylate or 2- or 3-hydroxypropyl methacrylate, or esters of the abovementioned monoethylenically unsaturated mono- or dicarboxylic acids with C₂-C₄-polyalkylene glycols, in particular the esters of these carboxylic acids with polyethylene glycol or alkyl polyethylene glycols, the (alkyl) polyethylene glycol residue usually exhibiting a molecular weight ranging from 100 to 3000. The monomers M2b furthermore include N-vinylamides, such as N-vinylformamide, N-vinylpyrrolidone, N-vinylimidazole or N-vinylcaprolactam. Preferred monomers M2b are acrylamide, methacrylamide, vinyl acetate or vinyl propionate. The optional proportion of the monomers M2b will preferably come to not more than 20% by weight, based on the total amount of the monomers M, and in particular not more than 10% by weight, e.g., from 0.01 to 10 and in particular from 0.01 to 5% by weight.

The monomers M2 furthermore include monoethylenically unsaturated and at least partially water-soluble monomers M2c which exhibit an aqueous solubility of at least 50 g/l and in particular of at least 100 g/l and which exhibit at least one cationic group and/or at least one group which can be protonated in the aqueous medium. The monomers M2c include in particular those which exhibit a protonatable amino group, a quaternary ammonium group, a protonatable imino group or a quaterized imino group. Examples of monomers with a protonatable imino group are N-vinylimidazole or vinylpyridines. Examples of monomers with a quaternized imino group are N-alkylvinylpyridinium salts or N-alkyl-N′-vinylimidazolinium salts, such as N-methyl-N′-vinylimidazolinium chloride or monosulfate. Preference is given, among the monomers M2c, in particular to the monomers of the general formula I

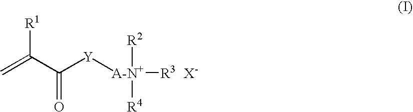

in which
R¹ is hydrogen or C₁-C₄-alkyl, in particular hydrogen or methyl,
R² and R³ are, independently of one another, C₁-C₄-alkyl, in particular methyl, and
R⁴ is hydrogen or C₁-C₄-alkyl, in particular hydrogen or methyl,
Y is oxygen, NH or NR⁵ with R⁵═C₁-C₄-alkyl,
A is C₂-C₈-alkylene, e.g. 1,2-ethanediyl, 1,2- or 1,3-propanediyl, 1,4-butanediyl or 2-methyl-1,2-propanediyl, if appropriate interrupted by 1, 2 or 3 nonadjacent oxygen atoms, and
X⁻ is an anion equivalent, e.g. halides, such as Cl⁻, BF₄⁻, HSO₄⁻, ½SO₄²⁻ or CH₃OSO₃⁻,
and, for R⁴═H, the free bases of the monomers of the formula I.

Examples of such monomers are 2-(N,N-dimethylamino)ethyl acrylate, 2-(N,N-dimethylamino)ethyl acrylate methochloride, 2-(N,N-dimethylamino)ethyl methacrylate, 2-(N,N-dimethylamino)ethylacrylamide, 3-(N,N-dimethylamino)propylacrylamide, 3-(N,N-dimethylamino)propylmethacrylamide, 2-(N,N-dimethylamino)ethylmethacrylamide, 2-(N,N,N-trimethylammonio)ethyl methacrylate chloride, 2-(N,N,N-trimethylammonio)ethylmethacrylamide chloride, 3-(N,N,N-trimethylammonio)propylacrylamide chloride, 3-(N,N,N-trimethylammonio)propylmethacrylamide chloride, 2-(N,N,N-trimethylammonio)ethylacrylamide chloride, and the corresponding monosulfate or sulfates. 2-(N,N-Dimethylamino)ethyl acrylate, 2-(N,N-dimethylamino)ethyl acrylate methochloride, or 2-(N,N-dimethylamino)ethyl methacrylate are preferred.

In one embodiment, the monomers M comprise at least one monomer M2c. The proportion of the monomers M2c is then advantageously not more than 20% by weight, based on the total amount of the monomers M, in particular from 0.01 to 10% by weight and particularly preferably from 0.01 to 7% by weight.

Preferably, the monomers M comprise, as monomers M1, methyl methacrylate, acrylonitrile, or the mixtures thereof, and optionally, as monomers M2a, acrylic acid, methacrylic acid, the mixtures thereof, or also the salts or salts of the mixtures thereof, and optionally, as monomers M2b, acrylamide, methacrylamide, or the mixtures thereof, and optionally, as monomers M2c, 3-(N,N-dimethylamino)propylmethacrylamide, 2-(N,N-dimethylamino)ethyl acrylate, the mixtures thereof, or the acid adducts thereof or the acid adducts of the mixtures.

Particularly preferably, the monomers M comprise, as monomers M1, methyl methacrylate, acrylonitrile, or the mixtures thereof, and, as monomers M2a, acrylic acid, methacrylic acid, the mixtures thereof, or also the salts or salts of the mixtures thereof, and optionally, as monomers M2b, acrylamide, methacrylamide, or the mixtures thereof, and optionally, as monomers M2c, 3-(N,N-dimethylamino)propylmethacrylamide, 2-(N,N-dimethylamino)ethyl acrylate, the mixtures thereof, or the acid adducts thereof or the acid adducts of the mixtures.

In addition, the monomers M include all ethylenically unsaturated monomers which can normally be used in an aqueous emulsion polymerization. For example, monomers exhibiting two or more nonconjugated ethylenically unsaturated double bonds can be used as monomers M. The proportion of monomers M exhibiting two or more nonconjugated ethylenically unsaturated double bonds usually, however, does not come to more than 5% by weight, in particular does not come to more than 2% by weight, e.g., from 0.01 to 2% by weight and in particular from 0.05 to 1.5% by weight, based on the total amount of the monomers M.

In one embodiment, the amount of monomers M1 is 100% by weight, based on the total amount of the monomers M. In an additional embodiment, the proportions of the monomers M1 to M2 are from 60 to 99.99% by weight to from 0.01 to 40% by weight, in each case based on the total amount of the monomers M. Preferably, the proportions of the monomers M1 to M2 are from 70 to 99.99% by weight to from 0.01 to 30% by weight, in each case based on the total amount of the monomers M. Particularly preferably, the proportions of the monomers M1 to M2 are from 80 to 99.99% by weight to from 0.01 to 20% by weight, in each case based on the total amount of the monomers M. In this connection, the total amount of the monomers M1 and M2 naturally comes to 100% by weight, which corresponds to the total amount of monomers M.

In another embodiment of the process according to the invention, the proportion of the monomers M2a and M2b and M2c is in each case not more than 20% by weight and in sum not more than 40% by weight, based on the total amount of the monomers M. Preferably, the proportion of the monomers M2a is not more than 20% by weight and of the monomers M2b not more than 10% by weight and of the monomers M2c not more than 10% by weight and in sum not more than 30% by weight, based on the total amount of the monomers M. Particularly preferably, the proportion of the monomers M2a is not more than 15% by weight and of the monomers M2b not more than 5% by weight and of the monomers M2c not more than 7% by weight and in sum not more than 20% by weight, based on the total amount of the monomers M.

In an advantageous embodiment of the invention, use is made, in the aqueous emulsion polymerization, of monomer mixtures comprising monomers M which act as crosslinking agents, such as allyl acrylate, allyl methacrylate, pentaerythritol triacrylate, pentaerythritol tetraacrylate, pentaerythritol trimethacrylate, pentaerythritol tetramethacrylate, ethylene glycol diacrylate, ethylene glycol dimethacrylate, butanediol diacrylate, butanediol dimethacrylate, trimethylolpropane triacrylate, trimethylolpropane trimethacrylate, butadiene, divinylbenzene, divinylurea or methylenebisacrylamide. Crosslinking agents sold by Sartomer under the following descriptions are also suitable: CN435, SR415, SR454, SR499, SR502: ethoxylated trimethylolpropane triacrylates; SR593: ethoxylated pentaerythritol triacrylate; SR9019: propoxylated glyceryl triacrylate; SR351 M: trimethylolpropane triacrylate; SR9021: highly propoxylated glyceryl triacrylate; SR9020: propoxylated glyceryl triacrylate; SR492: propoxylated trimethylolpropane triacrylates; SR368: tris(2-hydroxyethyl)isocyanurate triacrylate; SR355: ditrimethylolpropane tetraacrylate; SR399, SR399 LV: dipentaerythritol pentaacrylate; SR494: ethoxylated pentaerythritol tetraacrylate.

Furthermore, it has turned out to be advantageous for the particles according to the invention to exhibit a glass transition temperature Tg of at least 10° C., preferably of at least 20° C. and in particular of at least 30° C. In particular, the glass transition temperature will not exceed a value of 180° C. and particularly preferably 130° C. If the particles according to the invention are prepared by step polymerization and accordingly exist as core/shell particles or exist in the form of mixtures of different particles, the proportion of particles with a glass transition temperature of at least 10° C., preferably of at least 20° C. and in particular of at least 30° C. is, for example at least 40% by weight.

The term “glass transition temperature Tg” is understood here to mean the midpoint temperature determined by Differential Scanning Calometry (DSC) according to ASTM D 3418-82 (cf. Ullmann's Encyclopedia of Industrial Chemistry, 5th Edition, Volume A 21, VCH Weinheim 1992, p. 169, and A. Zosel, Farbe und Lack [Color and Paint], 82 (1976), pp. 125-134; see also DIN 53765).

In this connection is has turned out to be helpful to estimate the glass transition temperature Tg of the copolymer P. According to Fox (T. G. Fox, Bull. Am. Phys. Soc., (Ser. II) 1, 123 [1956], and Ullmanns Enzyklopädie der technischen Chemie [Ullmann's Encyclopedia of Industrial Chemistry], Weinheim (1980), pp. 17-18), the following equation is valid, to a good approximation, for the glass transition temperature of weakly crosslinked mixed polymers with high molar masses

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

in which X¹, X², . . . , Xⁿ represent the weight fractions of the monomers 1, 2, . . . , n and T_{g}¹, T_{g}², . . . , T_{g}ⁿ represent the glass transition temperatures in degrees Kelvin of the polymers (homopolymers) in each case synthesized only from one of the monomers 1, 2, . . . , n. The latter polymers are known, e.g., from Ullmann's Encyclopedia of Industrial Chemistry, VCH, Weinheim, Vol. A 21 (1992), p. 169, or from J. Brandrup and E. H. Immergut, Polymer Handbook, 3rd Ed., J. Wiley, New York, 1989.

The mean particle size of the particles according to the invention is at most 500 nm. The particle size distribution of the primary particles can be multimodal but also monomodal. The distribution can be narrow or also broad, depending on the reaction conditions. The mean particle size preferably ranges from 10 to 450 nm, in particular from 20 to 400 nm, particularly preferably from 30 to 350 nm and very particularly preferably from 40 to 300 nm. The particle sizes given here are weight-average particle sizes, such as can be determined by dynamic light scattering. Methods for this are familiar to a person skilled in the art, for example from H. Wiese in D. Distler, Wässrige Polymerdispersionen [Aqueous Polymer Dispersions], Wiley-VCH, 1999, chapter 4.2.1, p. 40ff, and the literature cited therein, and also H. Auweter and D. Horn, J. Colloid, Interf. Sci., 105 (1985), 399, D. Lilge and D. Horn, Colloid Polym. Sci., 269 (1991), 704, or H. Wiese and D. Horn, J. Chem. Phys., 94 (1991), 6429.

In principle, all organic substances with a low aqueous solubility which are used in the treating of organic polymers and which themselves cannot be polymerized under the conditions of the process for the preparation of the particles according to the invention are suitable as polymer additives. The term “polymer additives” is not to be understood as meaning agrochemical active substances, such as fungicides, herbicides or insecticides, or pharmaceutical active substances. The term “treating of organic polymers” is also to be understood as meaning the stabilization of organic polymers using the polymer additives. The polymer additives present in the particles according to the invention are either all identical or different. The expression “polymer additives” comprises an individual polymer additive and mixtures of polymer additives. The aqueous solubility of the essentially water-insoluble polymer additives is generally not more than 5 g/l, frequently not more than 3 g/l and in particular not more than 1 g/l, e.g., from 0.001 g/l to 1 g/l, in particular from 0.002 to 0.5 g/l. The solubility of the polymer additives in the monomers M1 depends on the details of the chemical nature of the polymer additives and can accordingly vary within wide ranges. The polymer additives can also be present in the monomers M1 partially, preferably to a low proportion, in the dispersed form. The polymer additives are generally soluble in the monomers M1 and insignificantly soluble in the monomers M2a-c.

The term “polymer additives” should be understood, in the context of the invention, as meaning in particular UV absorbers, stabilizers, auxiliaries, colorants or reactive sizing agents for paper. Stabilizers comprise UV stabilizers, light stabilizers or antioxidants for organic polymers. Auxiliaries comprise antifogging agents for organic polymers, lubricants for organic polymers, antistatic agents for organic polymers or flame retardants for organic polymers. Colorants comprise organic colorants which absorb light in the visible region, IR dyes or optical brighteners. A classification of the polymer additives in one of the abovementioned groups is not exclusive, i.e. the individual polymer additives may perfectly well display several actions, for example as stabilizer and as auxiliary.

The suitable polymer additives are according to the invention soluble in the monomers M1. The solubility of the polymer additives in the monomers M1 is, for example, at least 1 g/l, preferably at least 10 g/l. The amount of polymer additives which is present in the particles is, for example, from 0.5 to 60% by weight, preferably from 10 to 40% by weight, and generally ranges from 10 to 30% by weight, each time based on the total weight of the particles.

Use is particularly preferably made, as polymer additives, of UV absorbers which are soluble in the monomers M1. UV absorbers are frequently commercial products. They are sold, for example, under the Uvinul® trademark by BASF Aktiengesellschaft, Ludwigshafen. The Uvinul® light-stability agents comprise compounds of the following categories: benzophenones, benzotriazoles, cyanoacrylates and monomeric, or oligomeric hindered amines (HALS). The term “UV absorbers” is understood to mean compounds known to absorb UV rays which deactivate the absorbed radiation in nonradiative fashion. UV absorbers absorb light of the wavelength <400 nm and convert it into thermal radiation. Such compounds are used, for example, alone or in mixtures with other light-stability agents, in sunscreens and for stabilizing organic polymers. Examples of UV absorbers are derivatives of p-aminobenzoic acid, in particular the esters thereof, e.g. ethyl 4-aminobenzoate and ethoxylated ethyl 4-aminobenzoate, salicylates, substituted cinnamates, such as octyl p-methoxycinnamate or 4-isopentyl 4-methoxycinnamate, 2-phenylbenzimidazole-5-sulfonic acid or their salts. A UV absorber which is particularly preferably used is 4-(n-octyloxy)-2-hydroxybenzophenone. Additional examples of UV absorbers are:

substituted acrylates, such as, e.g., ethyl or isooctyl α-cyano-β,β-diphenylacrylate (principally 2-ethylhexyl α-cyano-β,β-diphenylacrylate), methyl α-methoxycarbonyl-β-phenylacrylate, methyl α-methoxycarbonyl-β-(p-methoxyphenyl)acrylate, methyl or butyl α-cyano-β-methyl-β-(p-methoxyphenyl)acrylate, N-(β-methoxycarbonyl-β-cyanovinyl)-2-methylindoline, octyl p-methoxycinnamate, isopentyl 4-methoxycinnamate, urocanic acid or the salts or esters thereof;
2-hydroxybenzophenone derivatives, such as, e.g., 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone, and 4-methoxy-2-hydroxybenzophenone-sulfonic acid, sodium salt; esters of 4,4-diphenylbutadiene-1,1-dicarboxylic acid, such as, e.g., the bis(2-ethylhexyl) ester;
2-phenylbenzimidazole-4-sulfonic acid and 2-phenylbenzimidazole-5-sulfonic acid, or the salts thereof;
benzoxazole derivatives;
benzotriazole or 2-(2′-hydroxyphenyl)benzotriazole derivatives, such as, e.g., 2-(2H-benzotriazol-2-yl)-4-methyl-6-(2-methyl-3-(1,1,3,3-tetramethyl-1-(trimethylsilyloxy)disiloxanyl)propyl)phenol, 2-(2′-hydroxy-5′-methylphenyl)benzotriazole, 2-(3′,5′-di(tert-butyl)-2′-hydroxyphenyl)benzotriazole, 2-(5′-(tert-butyl)-2′-hydroxyphenyl)benzotriazole, 2-[2′-hydroxy-5′-(1,1,3,3-tetramethylbutyl)phenyl]benzotriazole, 2-(3′,5′-di(tert-butyl)-2′-hydroxyphenyl)-5-chlorobenzotriazole, 2-(3′-(tert-butyl)-2′-hydroxy-5′-methylphenyl)-5-chlorobenzotriazole, 2-(3′-(sec-butyl)-5′-(tert-butyl)-2′-hydroxyphenyl)benzotriazole, 2-(2′-hydroxy-4′-octyloxyphenyl)benzotriazole, 2-(3′,5′-di(tert-amyl)-2′-hydroxyphenyl)benzotriazole, 2-[3′,5′-bis(α,α-dimethylbenzyl)-2′-hydroxyphenyl]benzotriazole, 2-[3′-(tert-butyl)-2′-hydroxy-5′-(2-octyloxycarbonylethyl)phenyl]-5-chlorobenzotriazole, 2-[3′-(tert-butyl)-5′-(2-(2-ethylhexyloxycarbonyl)ethyl)-2′-hydroxyphenyl]-5-chlorobenzotriazole, 2-[3′-(tert-butyl)-2′-hydroxy-5′-(2-methoxycarbonylethyl)phenyl]-5-chlorobenzotriazole, 2-[3′-(tert-butyl)-2′-hydroxy-5′-(2-methoxycarbonylethyl)phenyl]benzotriazole, 2-[3′-(tert-butyl)-2′-hydroxy-5′-(2-octyloxycarbonylethyl)phenyl]benzotriazole, 2-[3′-(tert-butyl)-5′-(2-(2-ethylhexyloxycarbonyl)ethyl)-2′-hydroxyphenyl]benzotriazole, 2-(3′-dodecyl-2′-hydroxy-5′-methylphenyl)benzotriazole, 2-[3′-(tert-butyl)-2′-hydroxy-5′-(2-isooctyloxycarbonylethyl)phenyl]benzotriazole, 2,2′-methylenebis[4-(1,1,3,3-tetramethylbutyl)-6-(benzotriazol-2-yl)phenol], the completely esterified product of 2-[3′-(tert-butyl)-5′-(2-methoxycarbonylethyl)-2′-hydroxyphenyl]-2H-benzotriazole with polyethylene glycol 300, [R—CH₂CH₂—COO(CH₂)₃—]₂ with R representing 3′-(tert-butyl)-4-hydroxy-5′-(2H-benzotriazol-2-yl)phenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole;
benzylidenecamphor or its derivatives, such as those mentioned, e.g., in DE-A 38 36 630, e.g. 3-benzylidenecamphor, 3-(4′-methylbenzylidene)-di-camphor;
α-(2-oxoborn-3-ylidene)toluene-4-sulfonic acid or its salts, N,N,N-trimethyl-4-(2-oxoborn-3-ylidenemethyl)anilinium monosulfate;
dibenzoylmethanes, such as, e.g., 4-(tert-butyl)-4′-methoxydibenzoylmethane;
2,4,6-triaryltriazine compounds, such as 2,4,6-tris{N-[4-(2-ethylhex-1-yloxycarbonyl)phenyl]amino}-1,3,5-triazine, 4,4′-((6-(((tert-butyl)aminocarbonyl)phenylamino)-1,3,5-triazin-2,4-diyl)imino)bis(benzoic acid 2′-ethylhexyl ester);
2-(2-hydroxyphenyl)-1,3,5-triazines, such as, e.g., 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyl-oxypropoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Additional suitable UV absorbers can be taken from the document Cosmetic Legislation, Vol. 1, Cosmetic Products, European Commission, 1999, pp. 64-66, to which reference is made herewith.

In addition, suitable UV absorbers are disclosed in lines 14 to 30 of page 6 of EP-A 1 191 041. Reference is made fully to these.

Furthermore, stabilizers for organic polymers are suitable as polymer additives. Stabilizers are compounds which stabilize organic polymers against decomposition under the action of oxygen, light or heat. They are also described as antioxidants or as UV and light stabilizers, cf. Ullmann's Encyclopedia of Industrial Chemistry, Vol. 3, 629-650 (ISBN-3-527-30385-5), and EP-A 1 110 999, page 2, line 29, to page 38, line 29. Virtually all organic polymers can be stabilized with such stabilizers, cf. EP-A 1 110 999, page 38, line 30, to page 41, line 35. This literature reference is made part of the disclosure content of the present invention by reference. The stabilizers disclosed in the EP application belong to the compound category of the pyrazolones, of the organic phosphites or phosphonites, of the sterically hindered phenols and of the sterically hindered amines (stabilizers of the “HALS” type or HALS stabilizers, cf. Römpp, 10th Edition, Volume 5, pages 4206-4207).

Auxiliaries for organic polymers are furthermore suitable as polymer additives. The term “auxiliaries” is understood to mean, for example, substances which at least largely prevent the fogging of films or molded articles made of plastic, known as antifogging agents. In addition, antifogging agents for organic polymers from which in particular sheets or films are prepared are suitable as polymer additives. Such polymer additives are described, for example, by F. Wylin, in Plastics Additives Handbook, 5th Edition, Hanser, ISBN 1-56990-295-X, pages 609-626.

Additional suitable polymer additives are lubricants, such as oxidized polyethylene waxes, and antistatic agents for organic polymers. Examples of antistatic agents, cf. the abovementioned literature reference F. Wylin, Plastics Additives Handbook, pages 627-645.

Additional suitable polymer additives are flame retardants, which are described, for example, in Römpp, 10th Edition, pages 1352 and 1353, and in Ullmann's Encyclopedia of Industrial Chemistry, Vol. 14, 53-71.

Commercial stabilizers and auxiliaries are sold, for example, under the brand names Tinuvin® and Cyasorb® by Ciba and Tenox® by Eastman Kodak. Stabilizers and auxiliaries are, for example, described in Plastics Additives Handbook, 5th Edition, Hanser Verlag, ISBN 1-56990-295-X. The stabilizers and auxiliaries are soluble in the monomers M1, at least 1 g/l, preferably at least 10 g/l, being dissolved.

Other polymer additives are organic colorants, which absorb light in the visible region, or optical brighteners. Such colorants and optical brighteners are described in detail in WO 99/40123, which is part of the state of the art, page 10, line 14, to page 25, line 25, to which reference is expressly made here. While optical colorants have an absorption maximum in the wavelength region from 400 to 850 nm, optical brighteners have one or more absorption maxima in the region from 250 to 400 nm. Optical brighteners are known, on being irradiated with UV light, to emit fluorescent radiation in the visible region. Examples of optical brighteners are compounds from the categories of the bisstyrylbenzenes, stilbenes, benzoxazoles, coumarins, pyrenes and naphthalenes. Commercial optical brighteners are sold under the Tinopal® (Ciba), Ultraphor® (BASF Aktiengesellschaft) and Blankophor® (Bayer) brands. Optical brighteners are also described in Römpp, 10th Edition, Volume 4, 3028-3029 (1998) and in Ullmann's Encyclopedia of Industrial Chemistry, Vol. 24, 363-386 (2003).

Additional suitable polymer additives are IR dyes, which are, for example, sold by BASF Aktiengesellschaft as Lumogen® IR. Lumogen® dyes comprise compounds of the categories of the perylenes, naphthalimides, or quaterrylenes.

The term “polymer additives” should also be understood to mean reactive sizing agents for paper, such as alkyldiketenes and alkenyl succinic anhydrides. Alkyldiketenes are used as pulp sizing agents in the preparation of paper and board, including cardboard. These polymer additives are essentially C₁₄-C₂₂-alkyldiketenes, such as stearyldiketene, palmityidiketene, behenyldiketene or oleyldiketene, and mixtures of the diketenes. Alkenyl succinic anhydrides are likewise used in the preparation of paper and paper products as pulp sizing agents. Examples of such sizing agents are the isomeric 4-, 5-, 6-, 7- and 8-hexadecenyl succinic anhydrides, decenyl succinic anhydride, octenyl succinic anhydride, dodecenyl succinic anhydride or n-hexadecenyl succinic anhydride, cf. also C. E. Farley and R. B. Wasser, The Sizing of Paper, Second Edition, (3), Sizing With Alkenyl Succinic Anhydride, TAPPI PRESS, 1989, ISBN 0-89852-051-7, pages 51-62.

The polymer additives can be distributed in any way in the particles according to the invention or can be situated on the surface thereof. For example, the polymer additives can be distributed homogeneously in the particles or be present in the particle in the form of aggregates. The polymer additives can be situated principally in the core or in the shell of the particles. The polymer additives can form domains and can, as is disclosed, for example, in PCT/EP2005/002534, form different architectures.

The preparation of the particles according to the invention comprises an aqueous emulsion polymerization of an oil-in-water emulsion of the monomers M, in which the monomer droplets of the emulsion comprise polymer additives. The terms “aqueous emulsion polymerization” and “emulsion polymerization” are used synonymously below. In this connection, the emulsion polymerization is carried out analogously to a conventional emulsion polymerization with the difference that the monomer emulsion to be polymerized comprises the polymer additives dissolved or partially dissolved in the monomer droplets.

The polymer additives can naturally also be soluble to a slight extent in the at least partially water-soluble monomers M2a-c; however, they are preferably located dissolved in the largely water-insoluble monomers M1. The monomers M2a-c react according to the style of a copolymerization with the monomers M1 to give the “Z-mers”. It is conceivable that these Z-mers then, as hydrophobic radical initiator entity, graft to the seed latex particles swollen with monomer and cure these. The mechanism of the transfer of the polymer additives and of the other hydrophobic chemicals through the aqueous phase is not completely clear; however, the seed latex particles present are possibly helpful in this transfer.

The oil-in-water emulsion of the polymer additive/monomer solution can be produced in situ by addition of a solution of the polymer additive in the monomers M to be polymerized in the polymerization vessel situated under polymerization conditions.

Preferably, however, polymer additives will be dissolved in the monomers M and the monomer solution thus obtained will be converted to an aqueous monomer emulsion, before the monomer/polymer additive emulsion thus obtained is fed to the polymerization reaction.

For the preparation of the particles according to the invention, the emulsion polymerization is carried out in the presence of a seed polymer (seed latex, seed). In this connection, it concerns a finely divided polymer latex, the mean particle size of which is usually not more than 100 nm, in particular not more than 80 nm and particularly preferably not more than 50 nm. In particular, the particle size of the seed is not more than 30 nm. The monomers constituting the seed latex are preferably chosen to at least 90% by weight, in particular at least 95% by weight and frequently to more than 99% by weight from the monomers M1, it being possible for the seed latex also to comprise, for stabilizing, small amounts, e.g. from 0.1 to 10% by weight, in particular from 0.1 to 5% by weight and especially from 0.1 to 1% by weight, of monomers M2 differing therefrom, e.g. monomers M2a. The seed latex frequently exhibits a glass transition temperature of at least 10, in particular of at least 50 and frequently of at least 80° C. The amount of seed latex is usually from 0.01 to 15% by weight, in particular from 1 to 10% by weight, based on the monomers M to be polymerized.

Preferably, the bulk, and in particular all, of the seed latex is present at the beginning of the emulsion polymerization completely in the reaction vessel. The seed latex can also be generated in situ in the polymerization vessel by radical emulsion polymerization of the monomers forming the seed latex. However, in this case, the formation of the seed latex is concluded before the preparation of the particles according to the invention begins. It is possible to feed in additional seed latex during the emulsion polymerization. The desired particle size of the seed latex can be controlled in a way known per se via the ratio of monomer to emulsifier. The seed can be prepared largely free from emulsifier with the help of protective colloids.

The processes standard in the state of the art for emulsion polymerizations, for example, are applicable to the preparation of the seed latexes. Generally, the operation is carried out with a or a mixture of low molecular weight surfactants; however, it is also possible to form seed latexes with oligomeric surfactants or protective colloids. It is also conceivable to use copolymerizable surfactants for the preparation of the latexes.

Preferably, the monomers forming the seed latex are chosen from the group consisting of C₁- to C₁₂-alkyl acrylates, C₁- to C₁₂-alkyl methacrylates, styrene, acrylonitrile or methacrylonitrile. Styrene or methyl methacrylate is particularly preferred. The seed latex is preferably crosslinked. One or more crosslinking agents can be used. Allyl acrylate, allyl methacrylate, pentaerythritol triacrylate, pentaerythritol tetraacrylate, pentaerythritol trimethacrylate, pentaerythritol tetramethacrylate, ethylene glycol diacrylate, ethylene glycol dimethacrylate, butanediol diacrylate, butanediol dimethacrylate, trimethylolpropane triacrylate, trimethylolpropane trimethacrylate, butadiene, divinylbenzene, divinylurea or methylenebisacrylamide are suitable as crosslinking agents. Naturally, mixtures of different seed latices can also be used in the context of the process according to the invention. The seed latices of these mixtures can exhibit identical or different compositions and particle size distributions.

Generally, the emulsion polymerization for the preparation of the particles according to the invention is carried out according to a “monomer feed process”, i.e. the bulk, preferably at least 70% and in particular at least 90%, of the solution of the polymer additive in the monomers M or the bulk, preferably at least 70% and in particular at least 90%, of the monomer/polymer additive solution or emulsion is fed, in the course of the polymerization reaction, to the polymerization vessel already comprising the seed latex.

The period of time for the addition of the monomer/polymer additive solution or emulsion (in the normal case, in this connection, a solution is involved but the polymer additive can also be present partially dispersed dissolved) can vary over a wide range depending on the composition. For example, the addition is carried out over a period of time of at least 0.5 h, preferably of at least 1 h, e.g., from 1 to 10 h and in particular from 2 to 5 h. The addition of the monomer/polymer additive solution or emulsion can be carried out with a constant or variable addition rate, e.g. in intervals with constant addition rate or with variable addition rate or continuously with variable addition rate. The composition of the monomer/polymer additive solution or emulsion can remain constant during the addition or can be changed, it being possible for changes to be carried out both based on the monomer composition and based on the type of the polymer additive or on the concentration of the polymer additive.

In the process according to the invention for the preparation of the particles, particles are obtained which exhibit a core/shell structure. The seed latex forms the core and the shell is formed from the monomers M. Different morphologies can be obtained for the particles depending on the course of the monomer addition. One or more distinguishable, at least partially unified, shells may be produced, for example 2 to 5 shells, or an essentially continuous transition between polymer regions may also be produced in one shell.

Such different polymer architectures of the dispersion particles are disclosed in the patent application PCT/EP2005/002534. This literature reference is made part of the disclosure content of the present invention by reference.

In a preferred embodiment of the invention, the monomer composition is changed, in the course of the monomer addition, in such a way that polymer regions with a different glass transition temperature are obtained in the shells of the particles. This is achieved by a “step polymerization”. For this, in a first step, a first monomer/polymer additive solution or emulsion, the monomer composition of which corresponds to a glass transition temperature T_{g}¹, is first polymerized in the presence of the core (seed latex) and moreover, subsequently, a second monomer/polymer additive solution or emulsion, the monomer composition of which corresponds to a glass transition temperature T_{g}² (2nd step), is provided and, if appropriate, following this, one or more additional monomer/polymer additive solutions or emulsions, the monomer composition of which corresponds each time to a glass transition temperature T_{g}ⁿ, n being the respective step, are successively provided. Preferably, the respective glass transition temperatures of polymers obtained in successive polymerization steps differ by at least 10 K, in particular by at least 20 K and particularly preferably by at least 30 K, e.g. from 30 K to 200 K, in particular from 40 K to 160 K. Generally, the amount of monomer polymerized in a step will come to at least 5% by weight, preferably at least 10% by weight, e.g. from 5 to 95% by weight, in particular from 10 to 90% by weight, in a two-step emulsion polymerization and from 5 to 90 or from 5 to 85% by weight, in particular from 10 to 80% by weight, in a three- or multistep emulsion polymerization, based on the total amount of monomers polymerized in all steps.

If crosslinked polymers should be prepared, it is possible, for example, to proceed in such a way that at least one crosslinking agent, either separately from the other monomers or in a mixture with the other monomers, is metered continuously into the reaction region. An additional variant consists in providing the crosslinking agent stepwise in the reaction region.

The initiator entities suitable for the emulsion polymerization according to the invention are the polymerization initiators suitable for an emulsion polymerization and conventionally used which initiate a radical polymerization of the monomers M. These include azo compounds, such as 2,2′-azobisisobutyronitrile, 2,2′-azobis(2-methylbutyronitrile), 2,2′-azobis[2-methyl-N-(2-hydroxyethyl)propionamide], 1,1′-azobis(cyclohexanecarbonitrile), 2,2′-azobis(2,4-dimethylvaleronitrile), 2,2′-azobis(N,N′-dimethyleneisobutyroamidine) dihydrochloride, or 2,2′-azobis(2-amidinopropane) dihydrochloride, organic or inorganic peroxides, such as diacetyl peroxide, ditert-butyl peroxide, diamyl peroxide, dioctanoyl peroxide, didecanoyl peroxide, dilauroyl peroxide, dibenzoyl peroxide, bis(o-toluoyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butylhydroperoxide, cumene hydroperoxide, tert-butyl peroxy(2-ethylhexanoate) or diisopropyl peroxydicarbamate, salts of peroxodisulfuric acid or redox initiator systems.

Preferably, use is made of water-soluble initiators, e.g. cationic azo compounds, such as azobis(dimethylamidinopropane), salts of peroxodisulfuric acid, in particular the sodium, potassium or ammonium salts, or a redox initiator system which, as oxidizing agent, a salt of peroxodisulfuric acid, hydrogen peroxide or an organic peroxide, such as tert-butyl hydroperoxide. They preferably comprise, as reducing agent, a sulfur compound chosen in particular from sodium hydrogensulfite, sodium hydroxymethanesulfinate or the hydrogen sulfite adduct of acetone. Additional suitable reducing agents are phosphorus-comprising compounds, such as phosphorous acid, hypophosphite or phosphinates, and also hydrazine or hydrazine hydrate or ascorbic acid. Furthermore, redox initiator systems can comprise an addition of small amounts of redox metal salts, such as iron salts, vanadium salts, copper salts, chromium salts or manganese salts, such as, for example, the redox initiator system ascorbic acid/iron(II) sulfate/sodium peroxodisulfate.

Generally, the initiator is used in an amount of 0.02 to 2% by weight and in particular of 0.05 to 1.5% by weight, based on the amount of the monomers M. The optimum amount of initiator naturally depends on the initiator system used and can consequently also lie below and/or above the amount mentioned and can be determined by a person skilled in the art by routine experiments. The initiator can be introduced partially or completely into the reaction vessel. Preferably, the bulk of the initiator, in particular at least 80% by weight, e.g. from 80 to 99.5% by weight of the initiator, is sent to the polymerization reactor in the course of the emulsion polymerization.

Pressure and temperature are of secondary importance for the preparation of the polymer additive compositions according to the invention. The temperature naturally depends on the initiator system used and an optimum polymerization temperature can be determined by a person skilled in the art through routine experiments. The polymerization temperature usually ranges from 10 to 110° C., frequently from 50 to 95° C. The emulsion polymerization is usually carried out under standard pressure or ambient pressure. However, it can also be carried out in the pressure range from 800 mbar to 3 bar.

In the process according to the invention, one or more surface-active substances are generally used to stabilize the particles in the aqueous medium. These include protective colloids or also low molecular weight emulsifiers, the latter, in contrast to the protective colloids, generally exhibiting a molecular weight of less than 2000 g/mol, in particular of less than 1000 g/mol (weight average). The protective colloids or emulsifiers can be both anionic, nonionic or cationic and zwitterionic in nature.

Examples of anionic surface-active substances are anionic emulsifiers, such as alkylphenylsulfonates, phenylsulfonates, alkyl sulfates, alkylsulfonates, alkyl ether sulfates, alkylphenol ether sulfates, alkyl polyglycol ether phosphates, alkyldiphenyl ether sulfonates, polyarylphenyl ether phosphates, alkyl sulfosuccinates, olefin sulfonates, paraffin sulfonates, petroleum sulfonates, taurides, sarcosides, fatty acids, alkylnaphthalenesulfonic acids or naphthalenesulfonic acids, including their alkali metal, alkaline earth metal, ammonium or amine salts.

Examples of anionic protective colloids are lignosulfonic acids, condensation products of sulfonated naphthalenes with formaldehyde or with formaldehyde and phenol and, if appropriate, urea, and also condensation products from phenolsulfonic acid, formaldehyde and urea, lignin sulfite waste liquor and lignosulfonates, and also polycarboxylates, such as polyacrylates, maleic anhydride/olefin copolymers (e.g. Sokalan® CP9, BASF Aktiengesellschaft), and also the alkali metal, alkaline earth metal, ammonium and amine salts of the abovementioned protective colloids. Additional protective colloids are synthetic polymers or copolymers which comprise, as monomers, the monomers listed under M2a, M2b, or M2c, or the mixtures thereof, and which are added, as polymers or copolymers, to the emulsion polymerization. Polysaccharides carrying anionic, nonionic or cationic groups are also suitable as protective colloids. These polysaccharides can, if appropriate, be decomposed in the reaction mixture.

Nonionic emulsifiers are, for example, alkylphenol alkoxylates, alcohol alkoxylates, fatty amine alkoxylates, polyoxyethylene glycerol fatty acid esters, castor oil alkoxylates, fatty acid alkoxylates, fatty acid amide alkoxylates, fatty acid polydiethanolamides, lanolin ethoxylates, fatty acid polyglycol esters, isotridecyl alcohol, fatty acid amides, methylcellulose, fatty acid esters, silicone oils, alkylpolyglycosides or glycerol fatty acid esters. Additional examples of suitable nonionic surface-active substances are ethoxylated mono-, di- and trialkylphenols (degree of ethoxylation: 3 to 50, alkyl radical: C₃-C₁₂) and ethoxylated fatty alcohols (degree of ethoxylation: 3 to 80; alkyl radical: C₈-C₃₆). Examples of fatty alcohols are the Lutensol® brands from BASF Aktiengesellschaft or the Triton® brands from Union Carbide. Particularly preferred are ethoxylated linear fatty alcohols of the general formula

n-CₓH₂ₓ₊₁—O(CH₂CH₂O)_{y}—H,

in which x are integers ranging from 10 to 24, preferably ranging from 12 to 20. The variable y preferably represents integers ranging from 5 to 50, particularly preferably from 8 to 40. Ethoxylated linear fatty alcohols usually exist as a mixture of different ethoxylated fatty alcohols with a different degree of ethoxylation. In the context of the present invention, the variable y represents the mean value (number-average). Suitable nonionic surface-active substances are furthermore copolymers, in particular block copolymers of ethylene oxide and at least one C₃-C₁₀-alkylene oxide, e.g. triblock copolymers of the formula

RO(CH₂CH₂O)_{y1}—(BO)_{y2}-(A-O)ₘ—(B′O)_{y3}—(CH₂CH₂O)_{y4}R′,

in which m represents 0 or 1, A represents a radical derived from an aliphatic, cycloaliphatic or aromatic diol, e.g. represents ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′ represent, independently of one another, propane-1,2-diyl, butane-1,2-diyl or phenylethane, y4 represent, independently of one another, a number from 2 to 100 and y2 and y3 represent, independently of one another, a number from 2 to 100, the sum y1+y2+y3+y4 preferably ranging from 20 to 400, which corresponds to a number-average molecular weight in the range from 1000 to 20000. Preferably, A represents ethane-1,2-diyl, propane-1,3-diyl or butane-1,4-diyl. Preferably, B represents propane-1,2-diyl.

Examples of nonionic protective colloids are polyethylene glycol, polypropylene glycol, polyethylene glycol/polypropylene glycol block copolymers, polyethylene glycol alkyl ethers, polypropylene glycol alkyl ethers, polyethylene glycol/polypropylene glycol ether block copolymers, and the mixtures thereof. Additional preferred nonionic protective colloids are polysaccharides or the decomposition products thereof.

Examples of cationic emulsifiers are quaternary ammonium salts, e.g. trimethyl- or triethyl(C₆-C₃₀-alkyl)ammonium salts, such as cocotrimethylammonium salts and trimethylcetylammonium salts, dimethyl- or diethyldi(C₄-C₂₀-alkyl)ammonium salts, such as didecyldimethylammonium salts or dicocodimethylammonium salts, methyl- or ethyl-tri(C₄-C₂₀-alkyl)ammonium salts, such as methyltrioctylammonium salts, (C₁-C₂₀-alkyl)-di(C₁-C₄-alkyl)benzylammonium salts, such as triethylbenzylammonium salts and cocobenzyldimethylammonium salts, methyl- or ethyldi(C₄-C₂₀-alkyl)poly(oxyethyl)-ammonium salts, e.g. didecylmethylpoly(oxyethyl)ammonium salts, N—(C₆-C₂₀-alkyl)-pyridinium salts, e.g. N-laurylpyridinium salts, N-methyl- or N-ethyl-N—(C₆-C₂₀-alkyl)-morpholinium salts, and N-methyl- or N-ethyl-N′—(C₆-C₂₀-alkyl)imidazolinium salts, in particular the halides, borates, carbonates, formates, acetates, propionates, hydrogencarbonates, sulfates or methyl sulfates.

Examples of cationic protective colloids are homo- and copolymers of the above-mentioned monomers M2c, which are added as homo- or copolymers to the emulsion polymerization, with a content of monomers M2c of at least 20% by weight, in particular at least 30% by weight of monomers M2c, for example homopolymers of N-vinyl-N-methylimidazolinium salts or of N-alkylvinylpyridinium salts and copolymers of these monomers with neutral monomers M2b which are preferably miscible with water. Cationic protective colloids can also be natural polymers, such as chitosan, or also cationically modified polysaccharides.

Zwitterionic emulsifiers are those with betaine structures. Such substances are known to a person skilled in the art and can be taken from the relevant state of the art (see, for example, R. Heusch, in Ullmann's Encyclopedia of Industrial Chemistry, 5th Ed., on CD-ROM, Wiley-VCH, 1997, “Emulsions”, chapter 7, Table 4). Gemini surfactants are likewise known to a person skilled in the art.

Additional examples of protective colloids are polyvinyl alcohols, cellulose derivatives, such as carboxymethylcellulose, polyvinylpyrrolidone, graft polymers of vinyl acetate and/or vinyl propionate on polyethylene glycols, polyethylene glycols closed at one or both ends with alkyl, carboxyl or amino groups, poly(diallyldimethylammonium chloride)s and/or polysaccharides, such as, in particular, water-soluble starches or starch derivatives, and proteins. Such products are described, for example, in Römpp, Chemie Lexikon [Chemistry Lexicon], 9th Edition, Volume 5, page 3569, or in Houben-Weyl, Methoden der organischen Chemie [Methods of Organic Chemistry], 4th Edition, Volume 14/2, chapter IV, Umwandlung von Cellulose und Stärke [Conversion of Cellulose and Starch] by E. Husemann and R. Werner, pages 862-915, and in Ullmann's Encyclopedia of Industrial Chemistry, 6th Edition, Volume 28, pages 533 ff, under Polysaccharides.

All types of starch, e.g. both amylose and amylopectin, native starches, hydrophobically or hydrophilically modified starches, anionic starches, cationically modified starches, degraded starches, the starch breakdown being able to be carried out, for example, oxidatively, thermally, hydrolytically or enzymatically, and both native and modified starches being able to be used for the starch breakdown, are suitable, for example. Additional suitable protective colloids are dextrins or crosslinked water-soluble starches which are swellable in water.

Use is preferably made, as protective colloid, of native water-soluble starches which can be converted into a water-soluble form, for example by starch decomposition, and also anionically modified starches, such as oxidized potato starch. Particular preference is given to anionically modified starches which have been subjected to a reduction in molecular weight. The reduction in molecular weight is preferably carried out enzymatically but can also be carried out hydrolytically or oxidatively. The average molar mass M, of the degraded starches is, for example, from 500 to 100000, preferably from 1000 to 30000. The degraded starches have, for example, an intrinsic viscosity [η] of 0.04 to 0.5 dl/g. Such starches are, for example, disclosed in EP-B-0 257 412 and in EP-B-0 276 770.

Maltodextrin (CAS # 9050-36-6), an aqueous hydrocarbon mixture which can be prepared by hydrolytic enzymatic or oxidative decomposition of starch or variants of their three processes, is suitable in particular as protective colloid. For example, Maltodextrin C* Pur 01915 from Cerestar is used.

If protective colloids are used in the emulsion polymerization, the amounts used are, for example, from 0.5 to 50% by weight, in particular from 5 to 40% by weight, more often than not from 10 to 30% by weight, based on the monomers M used in the emulsion polymerization.

Usually, the polymer dispersions according to the invention comprise at least one emulsifier, preferably at least one ionic emulsifier and, if appropriate, one or more nonionic emulsifiers.

The amount of emulsifier usually ranges from 0.1 to 15% by weight, in particular from 0.2 to 12% by weight and particularly preferably from 0.7 to 10% by weight, based on the monomers M. The amount of ionic emulsifier is in this connection preferably from 0.3 to 10% by weight and in particular from 0.5 to 8% by weight, based on the monomers M. The amount of nonionic emulsifier preferably ranges from 0.2 to 12% by weight, in particular from 0.5 to 10% by weight, based on the monomers M constituting the polymer.

The amounts of surface-active substances normally used for an emulsion polymerization normally lie in the ranges given above, so that all or a portion of the surface-active substances is fed via the emulsion polymerization. However, it is also possible to use only a portion, e.g. from 10 to 90% by weight, in particular from 20 to 80% by weight, of the surface-active substances in the emulsion polymerization and to add the remaining amount of surface-active substance subsequent to the emulsion polymerization, before or after a deodorizing of the emulsion polymerization to be carried out, if appropriate (subsequent saponification).

Naturally, the molecular weight of the polymers can be adjusted by addition of a small amount of modifiers, e.g. from 0.01 to 2% by weight, based on the polymerizing monomers M. Suitable modifiers are in particular organic thio compounds and also allyl alcohols or aldehydes. Polymerization modifiers and crosslinking agents can be used together in the emulsion polymerization. Because of this, it is possible, for example, to control the rheology of the polymer dispersions produced.

Subsequent to the actual polymerization reaction, it may be necessary to substantially free the aqueous polymer dispersions according to the invention from odor carriers, such as residual monomers and other volatile organic constituents. In a way known per se, this can be achieved physically by distillative removal (in particular via steam distillation) or by stripping with an inert gas. The reduction in the residual monomers can furthermore be carried out chemically by radical postpolymerization, in particular under the action of redox initiator systems, such as those listed, e.g., in DE-A 44 35 423, DE-A 44 19 518 and DE-A 44 35 422. Preferably, the postpolymerization is carried out with a redox initiator system of at least one organic peroxide and one organic sulfite.

After the end of the emulsion polymerization, the polymer dispersions thus obtained are, before their use according to the invention, frequently adjusted in alkalinity, preferably to pHs ranging from 7 to 10. Use may be made, for neutralizing, of ammonia or organic amines and also, preferably, of hydroxides, such as sodium hydroxide, potassium hydroxide or calcium hydroxide.

In this way, stable aqueous polymer dispersions are obtained comprising polymer additives in the particles of the polymer dispersion. In addition, the polymer dispersions thus obtained can comprise the abovementioned surface-active substances. The polymer dispersions according to the invention thus obtained are distinguished by a high stability and a low content of volatile organic compounds, which usually come to no more than 1% by weight, frequently no more than 0.1% by weight and in particular no more than 100 ppm, based on the total weight of the polymer dispersion. Volatile compounds are, here and subsequently, all organic compounds exhibiting, at standard pressure, a boiling point of less than 200° C. The polymer additives are at least partially coated by the water-insoluble polymers formed from the monomers M, i.e. the particles according to the invention comprise the polymer additives. Frequently, no measurable or only extremely low proportions of agglomerates or coagulates are observed, which generally come to less than 2% by weight, preferably less than 0.2% by weight, based on the solids present in the polymer dispersion.

The solids content of the polymer dispersions according to the invention is to a first approximation determined by the particles according to the invention and generally ranges from 10 to 60% by weight and in particular from 20 to 50% by weight.

Preferred particles according to the invention are those particles in which all characteristics have their preferred meaning.

Particles which comprise, as monomers M1, methyl methacrylate, methyl acrylate, ethyl acrylate, acrylonitrile, methacrylonitrile or mixtures of these monomers and the seed latex of which is based on polystyrene and/or polymethyl methacrylate or copolymers of styrene and methyl methacrylate are preferred in particular.

Particles which comprise, as monomers M1, methyl methacrylate, methyl acrylate, ethylacrylate, acrylonitrile or mixtures of these monomers and the seed latex of which is based on polystyrene and/or polymethyl methacrylate or copolymers of styrene and methyl methacrylate and which have been prepared with the help of protective colloids, the protective colloids being in particular polyvinyl alcohol or polyvinyl acetate or polysaccharides, which have been yet further cured with the help of crosslinking agents, such as glyoxal or glutardialdehyde, are furthermore preferred.

Particles which comprise, as monomers M1, methyl methacrylate, methyl acrylate, ethyl acrylate, acrylonitrile or mixtures of these monomers and the seed latex thereof is based on polystyrene and/or polymethyl methacrylate or copolymers of styrene and methyl methacrylate and which have been prepared with the help of emulsifiers, Dowfax® 2 A1, sodium lauryl sulfate or sulfosuccinic acid esters in particular being suitable as emulsifiers, are furthermore preferred. Dowfax® 2A1 comprises a 45% aqueous solution of 28-36% disodium dodecyl(sulfonatophenoxy)benzenesulfonate (CAS# 28519-02-0, EG-No. 249-063-8) and 8-15% of disodium oxybis(dodecylbenzenesulfonate) (CAS# 25167-32-2, EG-No. 246-688-8). The seed can comprise the same surfactants as are used for the emulsion polymerization or, however, different surfactants.

Particles which comprise, as monomers M1, methyl methacrylate, methyl acrylate, ethyl acrylate, acrylonitrile or mixtures of these monomers and the seed latex of which is based on polystyrene and/or polymethyl methacrylate or copolymers of styrene and methyl methacrylate and which have been prepared with the help of emulsifiers, mixtures of nonionic surfactants and anionic surfactants, such as, for example, the Lutensol® brands from BASF in combination with the abovementioned anionic surfactants, being in particular highly suitable as emulsifiers, are likewise preferred. The seed can comprise the same surfactants as are used for the emulsion polymerization or, however, different surfactants.

Particles which comprise, as monomers M1, methyl methacrylate, methyl acrylate, ethyl acrylate, acrylonitrile or mixtures of these monomers and the seed latex of which is based on polystyrene and/or polymethyl methacrylate or copolymers of styrene and methyl methacrylate and which have been prepared with the help of protective colloids, the protective colloids being in particular polyvinyl alcohol or polyvinyl acetate or polysaccharides, which have been yet further cured with the help of crosslinking agents, such as glyoxal or glutardialdehyde, and which furthermore have been prepared with the help of emulsifiers, Dowfax 2 A1, sodium lauryl sulfate, or sulfosuccinic acid esters being suitable in particular as emulsifiers, are furthermore preferred. The seed can comprise the same surfactants as are used for the emulsion polymerization or, however, different surfactants.

Particles which comprise, as monomers M1, methyl methacrylate, methyl acrylate, ethyl acrylate, acrylonitrile or mixtures of these monomers and the seed latex of which is based on polystyrene and/or polymethyl methacrylate or copolymers of styrene and methyl methacrylate and which have been prepared with the help of protective colloids, the protective colloids representing synthetic polymers, which comprise 3-(N,N-dimethylamino)propylmethacrylamide monomers and which have furthermore been prepared with the help of emulsifiers, Dowfax 2 A1, sodium lauryl sulfate, or sulfosuccinic acid esters being suitable in particular as emulsifiers, are furthermore preferred. The seed can comprise the same surfactants as are used for the emulsion polymerization or, however, different surfactants.

The polymer dispersions according to the invention can be used directly, as such or after diluting. In addition, the polymer dispersions according to the invention can also comprise conventional additives, e.g. viscosity-modifying additives (thickeners), antifoam agents, bactericides and antifreeze agents.

Suitable thickeners are compounds which confer a pseudoplastic flow behavior on the formulation, i.e. high viscosity at rest and low viscosity in the agitated state. Mention may be made, in this connection, for example, of polysaccharides or organic layered minerals, such as xanthan gum (Kelzan® from Kelco), Rhodopol® 23 (Rhône-Poulenc) or Veegum® (R. T. Vanderbilt) or Attaclay® (Engelhardt, magnesium aluminum silicate, palygorskite), xanthan gum preferably being used.

Silicone emulsions (such as, e.g., Silikon® SRE, Wacker, or Rhodorsil® from Rhodia), long-chain alcohols, fatty acids, fluoroorganic compounds and the mixtures thereof, for example, come into consideration as antifoam agents suitable for the polymer dispersions according to the invention.

Bactericides can be added to stabilize the polymer dispersions according to the invention against attack by microorganisms. Suitable bactericides are, for example, Proxel® from Avecia (or Arch) or Acticide® RS from Thor Chemie and Kathon® MK from Röhm & Haas.

Suitable antifreeze agents are organic polyols, e.g. ethylene glycol, propylene glycol or glycerol. These are normally used in amounts of not more than 10% by weight, based on the total weight of the polymer dispersion.

If appropriate, the polymer dispersions according to the invention can, to regulate the pH, comprise from 1 to 5% by weight of buffer, based on the total amount of the formulation prepared, the amount and type of the buffer used depending on the chemical properties of the polymer additives or of the polymers. Examples of buffers are alkaline salts of weak inorganic or organic acids, such as, e.g., phosphoric acid, boric acid, acetic acid, propionic acid, citric acid, fumaric acid, tartaric acid, oxalic acid and succinic acid.

In addition, the aqueous polymer dispersions according to the invention can be formulated with conventional binders, for example aqueous polymer dispersions, water-soluble resins, for example water-soluble alkyd resins, or with waxes.

The particles according to the invention are present in the polymer dispersions and can be obtained in powder form from these polymer dispersions by the removal of the volatile constituents of the liquid phase. The particles according to the invention can be present in the polymer powder either in the isolated form, in agglomerated form or partially in the film form. The polymer powders according to the invention are in this connection accessible, for example, by evaporation of the liquid phase, freeze drying or spray drying.

The polymer dispersions according to the invention are frequently accessible by a redispersing of the polymer powder according to the invention.

The polymer dispersions according to the invention and the polymer powders according to the invention which can be obtained therefrom by evaporation of the liquid phase have the advantage that they comprise the polymer additives over a long period of time in a controlled stable toward migration way, i.e. the polymer additives are associated with the particles over a relatively long period of time and are not released outside the particles to the surroundings. The polymer additives accordingly are present in a matrix which is particularly advantageous for their use. This fact applies in particular to those polymer dispersions or polymer powders comprising a UV absorber. The stability toward migration can, for example, be measured by spray drying the polymer dispersion according to the invention and subsequent extraction of the powder with tetrahydrofuran (THF) or other suitable liquids, the proportion of the polymer additives recovered by extraction being determined. Preferably, the polymer additives are present to at least 80% by weight in the polymer matrix; the proportion of the polymer additives which can be found in the matrix is particularly preferably at least 85% by weight, based on the total amount of polymer additive. The portion of polymer additive which is not located in the matrix frequently crystallizes and can be separated, for example by filtration.

The particles according to the invention in the form of their polymer dispersions or polymer powders are preferably used for the treating, in particular for the stabilizing, of organic polymers. The particles can, for this purpose, be incorporated in the organic polymers both as polymer dispersion and as powder according to the usual methods. Mention may be made here, by way of example, of the mixing of the particles with the organic polymers before or during an extrusion step. The term “organic polymers” is understood in this connection to mean any plastic, preferably thermoplastic, in particular films, fibers or molded articles of any shape. The organic polymers are, for example, polyethylene, polypropylene, polyamide, polyacrylonitrile, polycarbonate, acrylonitrile/butadiene/styrene (ABS), polyvinyl chloride or polyester. Additional examples of the treating or stabilizing of organic polymers with polymer additives can be taken from the Plastics Additives Handbook, 5th Edition, Hanser Verlag, ISBN 1-56990-295-X.

In order to stabilize a thermoplastic polymer against the action of UV radiation, it is possible, for example, to proceed in such a way that the polymer is first melted in an extruder, a powder comprising UV absorber prepared according to the invention is incorporated in the polymer melt at a temperature of, for example, from 180 to 200° C. and a granule is prepared therefrom from which films, fibers or molded articles stabilized against the action of UV radiation are then prepared according to known processes.

Naturally, mixtures of different particles according to the invention can also be used in the context of the use according to the invention. The particles of these mixtures can exert identical or different compositions and size distributions. For example, particles comprising UV absorbers can also be used together with other particles according to the invention, for example comprising stabilizers for organic polymers, such as antioxidants, for the stabilizing of organic polymers and paint films.

Those aqueous polymer dispersions according to the invention or the polymer powders obtained therefrom, e.g. by spray drying, comprising particles according to the invention comprising at least one antioxidant, for example phenolic compounds, are of industrial interest, for example. Furthermore, polymer powders comprising, as effect substance, at least one antistatic agent for organic polymers or an antifogging agent for organic polymers or a colorant for organic polymers or at least one reactive sizing agent for paper are of interest.

The particles according to the invention can, for the use in the treating, for example in the stabilizing, of organic polymers, also be used together with conventional additive systems in order to improve the overall effectiveness, for example with conventional emulsion concentrates, suspension concentrates, suspoemulsion concentrates of polymer additives. By mixing the particles according to the invention with conventional aqueous compositions of the abovementioned polymer additives, first a broadening of the spectrum of activity is achieved if the conventional composition comprises different polymer additives than the particles according to the invention. Secondly, the advantages of the particles according to the invention, in particular the improved stability toward migration, are not lost by formulating with conventional aqueous polymer additive compositions. Consequently, the application properties of a conventional aqueous polymer additive composition can be improved by formulating with particles according to the invention comprising the same polymer additives.

The polymer dispersions according to the invention are associated with a number of additional advantages. First, it concerns stable aqueous formulations of polymer additives which are insoluble in water or are soluble in water only to a slight extent. In particular, the phase separation problems observed with conventional formulations and also with micro- or nanodispersions of polymer additives and a deposition of the polymer additive are not observed, even on applying drastic conditions, such as those which sometimes occur in the treating of organic polymers with polymer additives. The content of volatile organic compounds is, as already described above, with conventional additivating, lower than with comparable conventional formulations and in comparison with micro- or nanodispersions of polymer additives. At the same time, the proportion of emulsifier is lower, based on the polymer additive used. The leaching by the action of water of the polymer additive from the organic polymer treated is clearly reduced in comparison with other formulations. Furthermore, interactions of the polymer additives with other formulation constituents or copolymer additives, as frequently occur with conventional formulating, are not observed. In addition, the decomposition of the polymer additives by the influence of substrate or environment, such as pH of the medium or UV radiation, is slowed down or even completely halted. A reduced effectiveness of the polymer additives through the incorporation in a polymer matrix is, surprisingly, generally not observed.

The process for the preparation of the particles according to the invention by aqueous emulsion polymerization using a seed latex makes possible very efficient access to the particles. The particles according to the invention are present, for example, as constituents of polymer dispersions or of polymer powders and can be readily incorporated in organic polymers.

The particles according to the invention are suitable in particular for the treating, for example against static charges or fogging, and/or stabilizing, for example against oxidation, the effect of UV radiation, heat and/or light, of organic polymers.

The following examples should clarify the invention, without, however, limiting it.

### EXAMPLES

### General Conditions

The particle sizes were measured by light scattering with a Coulter N4 Plus laser diffraction device or alternatively with a Coulter 230 LS. Measurements were always carried out in about 0.1% aqueous compositions.

All amounts given are, unless otherwise specified, given in % by weight.

### Charges:

| | |
|---|---|
| Maltodextrin C* | Maltodextrin from Cerestar. |
| Pur 01915 | |
| Dowfax ® 2A1 | 45% aqueous solution; |
| | 28-36% disodium dodecyl(sulfonatophenoxy)- |
| | benzenesulfonate (CAS# 28519-02-0, |
| | EG-No. 249-063-8) and |
| | 8-15% of disodium oxybis(dodecylbenzene- |
| | sulfonate) (CAS# 25167-32-2, EG-No. 246-688-8) |
| Uvinul ® 3008 | 2-Hydroxy-4-octyloxybenzophenone, |
| | CAS# 1843-05-6 |
| Rongalit C | Sodium salt of a sulfinic acid derivative, |
| | CAS # 79-25-4 |
| Uvinul ® 3033 P | 2-(2H-Benzotriazol-2-yl)-4-methylphenol, |
| | CAS# 2440-22-4 |
| Lipamin ® OK | Ethoxylated stearylamine which has been |
| | quaternized with dimethyl sulfate |

### Example 1

154 g of deionized water, 33.33 g of polystyrene seed (33%) with a particle size of about 30 nm and 55 g of Maltodextrin C* Pur 01915 were placed in a reactor flushed with nitrogen. The pot temperature was brought to 80° C. with stirring. 13.63 g of a mixture of 9.53 g of deionized water and 33 g of a 2% sodium peroxodisulfate solution (feed 2) were then added all at once.

Subsequently, a mixture of 545.66 g of deionized water, 8.8 g of Dowfax® 2A1, 2.64 g of pentaerythritol tetraacrylate, 217.36 g of methyl methacrylate and 44 g of Uvinul® 3008, which was dissolved in the monomers, (feed 1) was added in 3.5 h. Simultaneously, the remainder of feed 2 was added, likewise over a time of 3.5 hours.

After the end of feeds 1 and 2, the mixture was stirred for a further 30 min. A mixture of 2.93 g of deionized water and 4.4 g of tert-butyl hydroperoxide (feed 3) together with a mixture of 3.3 g of Rongalit C and 4.03 g of deionized water (feed 4) were now metered in 1 h.

Subsequently, the mixture was allowed to cool to ambient temperature (20° C.) and the polymer dispersion was filtered via a 500 μm and then via a 125 μm filter in order to remove the residual coagulate. The separated coagulate was 27.4 g in total. The solids content was determined at 28.5%. The mean particle size (bimodal) was 121 nm, after centrifuging 106 nm (monomodal), determined with the Beckman Coulter 230 LS.

Under a light microscope, at 1000 magnification, spherical crystals with needle-shaped hairs of Uvinul® 3008 could seldom be discerned and could easily be separated by filtration or centrifuging. The Uvinul® 3008 was present predominantly in the polymer matrix.

The spray drying of the polymer dispersion yielded a white powder. By extraction of the powder with THF, 87% of the Uvinul® 3008 could be recovered.

### Example 2

126 g of deionized water, 81.82 g of polystyrene seed (33%) with a particle size of about 30 nm and 63 g of Maltodextrin C* Pur 01915 were placed in a reactor flushed with nitrogen. The pot temperature was brought to 80° C. with stirring. 8.72 g of a mixture of 7.88 g of deionized water and 27 g of a 2% sodium peroxodisulfate solution (feed 2) were then added all at once.

Subsequently, a mixture of 570.27 g of deionized water, 7.2 g of Dowfax® 2A1, 2.16 g of pentaerythritol tetraacrylate, 177.84 g of styrene and 66.33 g of Uvinul® 3008, which was dissolved in the monomers, (feed 1) was added in 2 h. Simultaneously, the remainder of feed 2 was added, likewise over a time of 2 hours.

After the end of feeds 1 and 2, the mixture was stirred for a further 30 min. 3.6 g of a 10% aqueous tert-butyl hydroperoxide solution (feed 3) together with 2.70 g of a 10% aqueous Rongalit C solution (feed 4) were now metered in 1 h.

Subsequently, the mixture was allowed to cool to ambient temperature (20° C.) and the polymer dispersion was filtered via a 500 μm and then via a 125 μm filter in order to remove the residual coagulate. The separated coagulate was 26 g in total. The solids were determined at 25.4%. The mean particle size was 119 nm.

The spray drying of the polymer dispersion yielded a white powder.

### Example 3

147 g of deionized water, 31.82 g of polystyrene seed (33%) with a particle size of about 30 nm and 52.5 g of Maltodextrin C* Pur 01915 were placed in a reactor flushed with nitrogen. The pot temperature was brought to 80° C. with stirring. 10.17 g of a mixture of 9.2 g of deionized water and 31.5 g of a 2% sodium peroxodisulfate solution (feed 2) were then added all at once.

Subsequently, a mixture of 556.34 g of deionized water, 8.4 g of Dowfax® 2A1, 2.52 g of pentaerythritol tetraacrylate, 207.48 g of methyl methacrylate and 54.4 g of Uvinul® 3033 P, which was dissolved in the monomers, (feed 1) was added in 3.5 h. Simultaneously, the remainder of feed 2 was added, likewise over a time of 3.5 hours.

After the end of feeds 1 and 2, the mixture was stirred for a further 30 min. 4.2 g of a 10% aqueous solution of tert-butyl hydroperoxide (feed 3) together with 31.5 g of a 10% aqueous solution of Rongalit C (feed 4) were now metered in 1 h.

Subsequently, the mixture was allowed to cool to ambient temperature (20° C.) and the polymer dispersion was filtered via a 500 μm and then via a 125 μm filter in order to remove the residual coagulate. The separated coagulate was 21 g in total. The solids content was determined at 28.5%. The mean particle size was 99 nm. The content of residual MMA monomer was less than 0.1%.

The Uvinul® 3008 was present predominantly in the polymer matrix. The spray drying of the polymer dispersion yielded a white powder.

### Example 4

126 g of deionized water, 80 g of a PMMA seed (33.8%) with a particle size of 26 nm and a surface tension of 30.8 mN/m² and 63 g of Maltodextrin C* Pur 01915 were placed in a reactor flushed with nitrogen. The pot temperature was brought to 80° C. with stirring. 8.72 g of a mixture of 7.88 g of deionized water and 27 g of a 2% aqueous sodium peroxodisulfate solution (feed 2) were then added all at once.

Subsequently, a mixture of 572 g of deionized water, 7.2 g of Dowfax® 2A1, 2.16 g of pentaerythritol tetraacrylate, 177.8 g of MMA and 66.33 g of Uvinul® 3008, which was dissolved in the monomers, (feed 1) was added in 2 h. Simultaneously, the remainder of feed 2 was added, likewise over a time of 2 hours.

After the end of feeds 1 and 2, the mixture was stirred for a further 30 min. 3.6 g of a 10% aqueous tert-butyl hydroperoxide solution (feed 3) together with 2.70 g of a 10% aqueous Rongalit C solution (feed 4) were now metered in 1 h.

Subsequently, the mixture was allowed to cool to ambient temperature (20° C.) and the polymer dispersion was filtered via a 500 μm and then via a 125 μm filter in order to remove the residual coagulate. The separated coagulate was 31 g in total. The solids were determined at 27.1%. The mean particle size was 119 nm.

The spray drying of the polymer dispersion yielded a white powder.

### Example 5

147 g of deionized water and 31.82 g of polystyrene seed (33%) stabilized with Lipamin® OK were placed in a stirred flask flushed with nitrogen and heated to 80° C. with stirring. Subsequently, 17.11 g of a mixture of 187.59 g of deionized water, 2.76 g of 50% sulfuric acid, 0.46 g of allyl methacrylate, 13.80 g of Lipamin OK (40% aqueous solution), 46 g of Uvinul® 3008 and 91.54 g of styrene (feed 1) and 4.6 g of a 2% solution of the azo initiator entity V 50 (2,2′-azobis(2-methylpropionamidine) dihydrochloride) (feed 3) were added and grafting was carried out for 10 minutes. Subsequently, the remaining feed 1 was metered in 1.5 h and, simultaneously, the remaining feed 3 was metered in 3.5 h. After the end of feed 1, a mixture of 195.5 g of deionized water, 20.7 g of Lipamin OK, 1.84 g of a 50% aqueous sulfuric acid solution, 6.90 g of dimethylaminoethyl methacrylate and 131.1 g of methyl methacrylate (feed 2) was then metered in 2 hours. Postpolymerization was then allowed to take place for a further 30 minutes. A solution of 20.7 g of deionized water and 2.3 g of a 10% aqueous solution of tert-butyl hydroperoxide in a was then added and a mixture of 1.63 g of Rongalit C and 19.09 g of deionized water was then metered in an hour. The mixture was then allowed to cool to ambient temperature and the dispersion was filtered via a 500 and a 125 μm filter in order to remove the coagulate.

The separated coagulate was 2.1 g in total. The solids content was determined at 28.7%. The mean particle size was 120 nm.

The spray drying of the polymer dispersion yielded a white powder. The residual content of methyl methacrylate monomer was 969 ppm and the residual content of styrene monomer was 11 ppm.

The Uvinul® 3008 was virtually completely encapsulated.

### Comparative Example 1

If example 2 was repeated without the use of the polystyrene seed, no suitable dispersions were obtained. The Uvinul® 3008 could be found largely nonencapsulated on the stirrer and on the wall of the reactor. The dispersion had a solids content of 22%.

1: A particle which can be obtained by aqueous emulsion polymerization of ethylenically unsaturated monomers M in the presence of polymer additives and of seed latexes, in which the monomers M comprise
a largely water-insoluble monomers M1, wherein said monomers M:
c are essentially water-insoluble,
d are soluble in the monomers M1, and
e cannot be polymerized under conditions for the preparation of the particle and the particle exhibits a mean particle size of at most 500 nm.

2: The particle according to claim 1, comprising, as polymer additives, UV absorbers, stabilizers, auxiliaries, colorants or reactive sizing agents for paper.

3: The particle according to claim 1, wherein the monomers M1 are monomers M.

4: The particle according to claim 1, further comprising at least one partially water-soluble monomer M2.

5: The particle according to claim 1, the seed latexes are generated in-situ before the preparation of the particle.

6: The particle according to claim 1, obtained by aqueous emulsion polymerization additionally in the presence of protective colloids.

7: A polymer dispersion, comprising the particle according to claim 1.

8: A process for the preparation of aqueous polymer dispersions, the dispersed particles of which exhibit a mean particle size of at most 500 nm and comprise polymer additives, comprising the aqueous emulsions polymerization of ethylenically unsaturated monomers M, comprising
a largely water-insoluble monomers M1, and
wherein, in the presence of polymer additives and seed latexes, the polymer additives are essentially water-insoluble and soluble in the monomers M1 and the polymer additives are not polymerized under the conditions of the process for the preparation of the particle according to the invention.

9: A polymer powder, which can be obtained by removing the volatile constituents of an aqueous polymer dispersion according to claim 7.

10: A polymer dispersion, which can be obtained by redispersing the polymer powder according to claim 9.

11-12. (canceled)

13: The process according to claim 8, wherein said monomers M further comprise at least one partially water-soluble monomer M2.

14: The particle according to claim 4, wherein said monomer M2 is at least one monomer M2b selected from the group consisting of an amide of an ethylenically unsaturated carboxylic acid, a hydroxyalkyl ester of an α,β-ethylenically unsaturated C₃-C₈-monocarboxylic acid, a hydroxyalkyl ester of an α,β-ethylenically unsaturated C₄-C₈-dicarboxylic acid, an ester of a monoethylenically unsaturated monocarboxylic acid with C₂-C₄-polyalkylene glycols, an ester of a monoethylenically unsaturated dicarboxylic acid with C₂-C₄-polyalkylene glycols, and an N-vinylamide.

15: A method for stabilizing a polymer dispersion, comprising mixing within said dispersion at least one particle according to claim 1.
